(19) United States
(12) Patent Application Publication
(10) Pub. No.: US 2010/0171767 A1
(43) Pub. Date: Jul. 8, 2010

(54) METHOD FOR DISPLAYING INFORMATION IN A MOTOR VEHICLE, AND INFORMATION SYSTEM

(76) Inventors: Christoph Waeller, Braunsweig (DE); Jens Fliegner, Wahrenholz (DE)

Correspondence Address: KENYON & KENYON LLP, ONE BROADWAY, NEW YORK, NY, 10004, US

(21) Appl. No.: 12/377,102

(22) PCT Filed: Jul. 16, 2007
(86) PCT No.: PCT/EP07/06275

§ 371 Date: Feb. 10, 2009

(30) Foreign Application Priority Data
Aug. 31, 2006 (DE) 10 2006 00 947.7
Mar. 9, 2007 (DE) 10 2007 011 542.5

(51) Int. Cl. G09G 5/00

(52) U.S. Cl. 345/672

(57) ABSTRACT

In a method for displaying information in a motor vehicle, including a display device having a display with which different content may be displayed as a function of the viewing angle, basic information is shown for a first viewing angle and a second viewing angle, and in addition to the basic information, first supplementary information is shown for the first viewing angle and second supplementary information is shown for the second viewing angle. Furthermore, an information system is adapted for implementing the method.

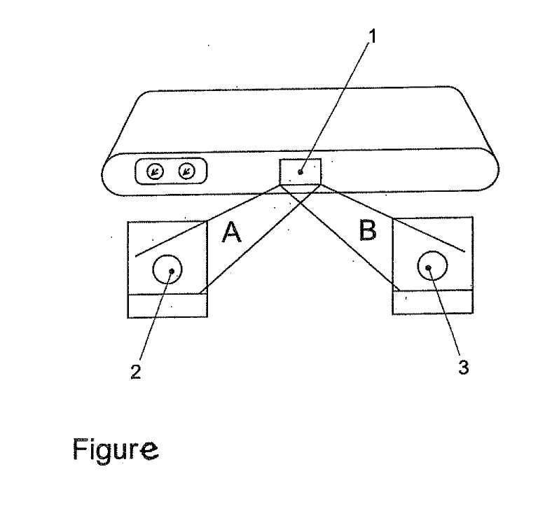

### FIELD OF THE INVENTION

The present invention relates to a method for displaying information in a motor vehicle, including a display device having a display with which different content may be displayed for different viewing angles. Furthermore, the present invention relates to an information system for occupants of a motor vehicle, including a display device having such a display and a control device, which controls the display of the content displayed by the display for at least two viewing angles.

### BACKGROUND INFORMATION

During a car ride, the driver must concentrate on steering the vehicle, while the front-seat passenger frequently has no specific tasks. These differences in assigned roles may lead to discrepancies in the selection of display content on displays installed in the vehicle. The driver requires information relevant to driving, such as the map view of a navigation device, whereas the front-seat passenger has an interest in the display of entertainment content on the display, such as films or a TV channel.

A driver information system having a screen in a motor vehicle is described in German Published Patent Application No. 42 13 129. The screen of the driver information system is disposed in the region of the center console and can be swiveled around a vertical axis. The display on this screen is controlled such that traffic information is displayed if the screen is directed toward the driver's seat. In the swivel position directed toward the front-seat passenger's seat, TV entertainment may also be displayed, for example.

Furthermore, liquid crystal displays that use an optical barrier to display a different image to the viewer to the right and left of the middle viewing axis, respectively, are known. Such displays are distributed by the company Sharp, for example, under the name dual-view display.

It is conventional to use such dual-view displays in a motor vehicle in order to display to the driver content that is different than that displayed to the front-seat passenger. For example, the display of a navigation system may be made available to the driver, while the front-seat passenger may simultaneously watch a film.

### SUMMARY

Example embodiments of the present invention provide a method for displaying information in a motor vehicle, and an information system of the type mentioned above with which information may be displayed to different vehicle occupants as needed in a flexible manner and in accordance with the respective role of the occupant.

The method according to example embodiments of the present invention provides that basic information is shown for a first and second viewing angle, and that in addition to the basic information, first supplementary information is shown for the first viewing angle and/or second supplementary information is shown for the second viewing angle. The first and second supplementary information may differ so that a viewer from the first viewing angle and a viewer from the second viewing angle respectively see the basic information. In particular, the supplementary information may superimpose the basic information. In the present context, supplementary information may also mean a revised display of the basic information. The basic information provides both vehicle occupants, who view the display from the two viewing angles, with a basis of discussion for communication. However, the displays for both viewing angles differ with regard to the display of supplementary information so that the display may be adjusted to the role of the vehicle occupant.

According to example embodiments of the present invention, the basic information is a map display for a navigation device. In this context, fewer points of interest are shown for the first viewing angle than are shown for the second viewing angle, for example. Furthermore, the points of interest shown for the first viewing angle may differ from those shown for the second viewing angle. In addition, the points of interest may be displayed such that they are larger for the first viewing angle than for the second viewing angle.

In the method, the display is disposed such that the driver views the display from the first viewing angle and the front-seat passenger views the display from the second viewing angle. In this manner, fewer points of interest may be shown to the driver in accordance with his cognitive stress, and significantly more may be shown to the front-seat passenger. The reduced display for the driver increases the safety during operation of the vehicle. At the same time, the information content is able to be increased through the unrestricted display of points of interest for the front-seat passenger. By adjusting to the viewing angle the selection of the points of interest displayed, it is possible to take into account that driver and front-seat passenger are interested in different topics. For example, for the driver it may be more important for gas stations to be displayed in the map display; for the front-seat passenger, points of interest relating to shopping options or events may be more important. In the method, the individual interests of both the driver and the front-seat passenger are satisfied even though only one display is used.

The display of the points of interest in different sizes takes into account that the driver must recognize the points of interest quickly and clearly, whereas the front-seat passenger may be allowed more time to read the display. He may focus visually for a long time, and thus may also read well points of interest that are displayed in a smaller size.

In accordance with example embodiments of the present invention, the display is touch-sensitive and the points of interest may be selected by touching assigned icons on the map display. If the icons of the points of interest are displayed in a larger size for the driver, he is able to more easily select points of interest without being distracted from the steering of the vehicle. On the other hand, the icons may be displayed in a smaller size for the front-seat passenger so that an optimized layout may be displayed.

According to example embodiments of the present invention, the points of interest may be selected using at least one offset operating element as an alternative to or in addition to the touch-sensitive display. In this context, the offset operating element may provide for the selection of control fields that are displayed on the display.

In accordance with example embodiments of the present invention, selectable supplementary information assigned to the points of interest is shown only for the second viewing angle, that is, for the front-seat passenger. Thus, the front-seat passenger may select the point of interest via the touch-sensitive display or via the offset operating element and thus initiate the display of an extensive menu. This menu remains hidden for the driver, to avoid distracting him. In example embodiments of the method, the operating user and his seating position, respectively, are identified in order to implement the separate use of the same touch-sensitive display or of the same display for selection via the offset operating element. The separate operation of the display, in particular the touch-sensitive display, has the advantage that operator actions of the front-seat passenger, which are not relevant for the driver, do not disturb the driver's display.

For example, the position of a finger of the driver or of the front-seat passenger may be detected by a capacitive coupling between the finger and a receiving device disposed near a control zone. The receiving device may be included in the display device, in particular in the display, so that the user's finger, which is located on or only in front of an operating function shown on the display, is detected. In this context, the finger may touch the display; however, this is not necessarily required. For the capacitive coupling with the receiving device, it is sufficient for the finger to be located a certain distance in front of the display.

Furthermore, the receiving device may be included in the offset operating element or near this operating element if operator actions are able to be initiated via this operating element. In addition, it would be possible to provide separate offset operating elements for different vehicle occupants.

The seating position of the driver or front-seat passenger may be identified in that an identification code is capacitively coupled into the body of the respective user by an electrode device and capacitively decoupled from the body of the user at the receiving device. In this context, the identification code is in particular able to be coupled into the body of a user only if this user is sitting in a seating position that is assigned to the electrode device. The identification code may thus be transmitted by quasi electrostatic fields to the receiving device via the body of the user. A capacitor device may be used for the interfaces between the electrode device and the user, and between the user and the receiving device, respectively, which capacitor device is integrated into a resonant circuit that is operated as a parallel resonant circuit in the receiving device and as a series resonant circuit in the electrode device.

The identification code may identify the user and/or the seating position, for example. A user-selective operation may be implemented in this manner. Additionally, the type of information displayed for a viewing angle may be a function of the identification code of the user in the seating position assigned to this viewing angle. Thus, it is possible for the decision regarding whether specific information is allowed to be displayed to be a function of the seating position. For example, in this manner, it is possible to prevent a film from being displayed for the driver's viewing angle while the vehicle is being driven.

According to example embodiments of the present invention, specific supplementary information relevant for the driver is shown only for the first viewing angle. For example, detailed navigation instructions, such as an arrow display or meter specifications, are significantly more important for the driver than for the front-seat passenger. Furthermore, a reduced map display may be displayed for the first viewing angle and a complete map display for the second viewing angle. For example, on the basis of the reduced map display, the driver may orient himself immediately with one glance at the map. For example, it is possible to display only an orientation corridor to the driver, in which irrelevant street regions are hidden. Since this reduction of the roads is less meaningful to the front-seat passenger, the complete road view is shown to the front-seat passenger. The reduction of the map display thus has the advantage that the driver is able to perceive the information content more quickly.

According to example embodiments of the present invention, the depth of detail for the first viewing angle changes as a function of speed. For example, during standstill, both the driver and the front-seat passenger may receive a display having the same depth of detail. During the drive, the information display for the driver's viewing angle is reduced or modified as cognitive stress increases. For example, fewer elements may be displayed. In addition, the conciseness may be increased. On the other hand, the display for the viewing angle of the front-seat passenger may be retained completely, with regard to depth of detail and scope of operation, independently of the situation.

Furthermore, warning messages are displayed on the display as a function of the viewing angle in order to ensure that they are noticed. In particular, warnings that are relevant to driving and that relate to traffic information or the operating state of the motor vehicle are shown as supplementary information for the first viewing angle, that is, the driver.

The information system according to example embodiments of the include a control device that controls the display such that basic information is able to be displayed for both viewing angles and, in addition to the basic information, first supplementary information is able to be shown for the first viewing angle, and/or second supplementary information is able to be shown for the second viewing angle in addition to the basic information. In particular, the supplementary information is able to be shown in a superimposed manner.

According to example embodiments of the present invention, the information system includes a navigation device in particular, the basic information being the map display for the navigation device.

The display of the information system and of the navigation device may be touch-sensitive, it being possible to select the points of interest by touching assigned icons on the map display.

According to example embodiments of the present invention, the information system includes at least one offset operating element. In this case, the points of interest may by selected alternatively or additionally using this offset operating element. In particular, the offset operating element is a mechanical operating element. For example, a rotary switch may be provided via which control elements displayed on the display may be controlled and selected by pressing the rotary switch. Additionally, separate pressure switches may be disposed around the rotary switch, the arrangement of display fields, which are assigned to the pressure switches, on the display corresponding to the arrangement of the pressure switches at least schematically. The information system may include a multifunction operating device as described in European Patent No. 1 212 208, for example.

According to example embodiments of the information system, the information system is coupled to a speedometer. In this case, the depth of detail of the display for the first viewing angle may be modified by the control device as a function of speed.

In general, the display for the driver may differ from the display for the front-seat passenger or one of the other vehicle occupants only if the speed of the vehicle is greater than zero or exceeds a specific threshold value.

Example embodiments of the present invention are explained in greater detail below with reference to the appended FIGURE.

### BRIEF DESCRIPTION OF THE DRAWING

The FIGURE schematically illustrates the display of an information system according to an example embodiment of the present invention relative to the driver and the front-seat passenger of the motor vehicle.

### DETAILED DESCRIPTION

The exemplary embodiment of an information system described below relates to a navigation device for a motor vehicle and a method for displaying information for such a navigation device. However, the present invention is not limited to such an information system. Rather, it relates to any type of information display in a motor vehicle in which multiple vehicle occupants are to be provided with the same basic information, which may be superimposed by different supplementary information as a function of the viewing angle.

A navigation device includes a device for determining the position of the motor vehicle, such as a GPS (Global Positioning System) receiver, a memory in which digital road maps are stored, and a control device, which evaluates the signals of the GPS receiver such that a road map is displayed in the vicinity of the current position on a display. Furthermore, supplementary information, such as what are referred to as points of interest, may be shown as icons in the digital road map.

For example, a dual-view display from the company Sharp is used as a display, in which different content may be displayed to a viewer to the right and left of the middle viewing axis, respectively, through an optical barrier. The arrangement of display 1 is shown in the FIGURE. Driver 2 of the motor vehicle views display 1 from a viewing angle A; front-seat passenger 3 views display 1 from a viewing angle B. The optical barrier of display 1 is disposed such that a different display is seen from region A than from region B. The control device may control the image shown for first viewing angle A separately from the image shown for viewing angle B.

The control device divides content displayed for both viewers 2 and 3 into three categories: The first category relates to basic information that is to be displayed to both driver 2 and front-seat passenger 3. In the exemplary embodiment described, this is the basic map display of the navigation device. The scale and the displayed section of the surroundings is the same for driver 2 and front-seat passenger 3. Also, a control, which may be conventional, of these navigation device parameters by driver 2 or front-seat passenger 3 leads to corresponding changes to the display for both vehicle occupants. This basic map display offers a shared basis of conversation for both users and thus stimulates communication and social interaction in the vehicle more than a radical separation of display content, as is provided in certain conventional devices.

The second category relates to information that is to be displayed to driver 2 only. It is thus superimposed on the basic map display for first viewing angle A.

The third category relates to information that is to be displayed to front-seat passenger 3 only. It is thus accordingly superimposed on the basic map display for second viewing angle B.

In this context, the displays for driver 2 and front-seat passenger 3 differ as follows:

Number of displayed points of interest: In accordance with his cognitive stress, fewer points of interest are displayed to driver 2 than to front-seat passenger 3.

Selection of displayed points of interest: For example, driving-relevant information, such as traffic information and warnings, are shown to driver 2, and information that is not relevant to driving, such as points of interest for shopping options and events, are shown to front-seat passenger 3.

Size of displayed points of interest: While front-seat passenger 3 is allowed more time for operation and may visually focus on the display for a long time, driver 2 must be able to operate the display quickly and clearly. The display is arranged as a touch-sensitive display for operation of the navigation device. The icons for the points of interest are displayed in a larger size, and thus are more easily “hittable,” for driver 2 than for front-seat passenger 3.

Opening of a menu for a point of interest for only one user: Front-seat passenger 3 may select a point of interest via the assigned icon and thus open a more extensive menu. This menu remains hidden from driver 2, however, so as not to distract him. That is, this menu is not shown for viewing angle A of driver 2.

Navigation overlays: Detailed navigation instructions, such as an arrow display or meter specifications, are significantly more important for driver 2 than for front-seat passenger 3. Thus, on the map, the navigation instructions are made visible only to driver 2.

Number of roads displayed: It is important that driver 2 be able to orient himself immediately when glancing at the map. For this reason, in the display for driver 2, irrelevant road regions are hidden in a targeted manner and, for example, only an orientation corridor displayed. Since this reduction of the roads is less meaningful to front-seat passenger 3, the complete road view is shown to front-seat passenger 3.

Navigation device 11 is connected to the speedometer of the motor vehicle, e.g., in a generally conventional manner. The control device evaluates the information of the speedometer for the information display for driver 2 such that during standstill driver 2 and front-seat passenger 3 receive the same display, in particular the same depth of detail. During the drive, as cognitive stress increases, that is, as speed increases, the information display is reduced or modified in the view of driver 2. Fewer elements, in particular fewer points of interest, are displayed. Furthermore, the conciseness of the display of the points of interest is increased. The display of front-seat passenger 3 is independent of the situation and the speed. The full range of information and operation is provided to front-seat passenger 3 continuously.

For the separate use of the same touch-sensitive display for operator tasks that correspond to the visible elements of only one of the two sides, the navigation device identifies the operating user and his seating position. For example, this identification of the user and his seating position takes place as follows:

An electrode array is located in the seat of driver 2. This electrode array may be used to capacitively couple an identification code into the body of driver 2. The identification code may identify the seating position of user 2 as well as user 2 himself. The identification code is transmitted via the body of driver 2 and capacitively decoupled at the finger tip, so that it may be transmitted to a receiving device accommodated in the display device, in particular in display 1.

The receiving device is connected to a control device, which in turn is capacitively coupled to the electrode device. An electric field having a very limited range of several centimeters or decimeters, for example, is used for the capacitive couplings between the electrode device and driver 2 on the one hand, and driver 2 and the receiving device in the display device on the other hand. The range of this field determines the size of the control zone in front of the display surface on which the operating function is displayed. Relatively low carrier frequencies of several 100 kH are used for the signal transmission, which lead to quasi-static fields, that is, fields for which for the most part the physical principles that apply for static fields are valid.

With regard to further details of this signal transmission, reference is made to German Published Patent Application No. 10 2004 048 956 and the additional literature cited therein, which are expressly incorporated herein in their entireties by reference thereto. In particular, the control devices used in German Published Patent Application No. 10 2004 048 956 may be used.

The detection of front-seat passenger 3 and the identification of his seating position may optionally ensue in the same manner as with driver 2. When an operating function is activated, the information regarding the position from which a control zone was activated, and optionally regarding who activated which control zone, is thus available in the control device.

It is also possible to use an operating device having one or more offset operating elements instead of a touch-sensitive display 1. The operating elements may be used to activate and select control buttons that are displayed on the display to driver 2 and front-seat passenger 3, or only to the driver, or only to front-seat passenger 3. For example, a rotary switch having a pressure function may be used. Furthermore, a multifunction operating device could be used, as described, for example, in European Patent No. 1 212 208.

### LIST OF REFERENCE CHARACTERS

1 display
2 driver
3 passenger
A first viewing angle of the driver
B second viewing angle of the front-seat passenger

1-17. (canceled)

18. A method for displaying information in a motor vehicle, the motor vehicle including a display device having a display adapted to display different content for different viewing angles, comprising:
displaying, on the display, basic information for a first viewing angle and a second viewing angle; and
displaying, on the display, at least one of (a) first supplementary information, in addition to the basic information, for the first viewing angle and (b) second supplementary information, in addition to the basic information, for the second viewing angle.

19. The method according to claim 18, wherein the basic information includes a map display for a navigation device.

20. The method according to claim 19, wherein fewer points of interest are displayed for the first viewing angle than for the second viewing angle.

21. The method according to claim 19, wherein different points of interest are displayed for the first viewing angle than for the second viewing angle.

22. The method according to claim 19, wherein points of interest are displayed in a larger size for the first viewing angle than for the second viewing angle.

23. The method according to claim 19, wherein the display is touch-sensitive, the method further comprising selecting points of interest by touching assigned icons on the map display.

24. The method according to claim 19, further comprising selecting points of interest using at least one offset operating element.

25. The method according to claim 23, wherein the displaying of supplementary information includes displaying selectable supplementary information assigned to the points of interest only for the second viewing angle.

26. The method according to claim 18, wherein the displaying of supplementary information includes displaying specific supplementary information relevant for a driver only for the first viewing angle.

27. The method according to claim 19, wherein a reduced map display is displayed for the first viewing angle and a complete map display is displayed for the second viewing angle.

28. The method according to claim 18, further comprising modifying a depth of detail for the first viewing angle as a function of speed.

29. A method for displaying information in a motor vehicle, the motor vehicle including a display device having a display adapted to display different content for different viewing angles, comprising:
displaying, on the display, basic information for a first viewing angle and a second viewing angle; and
displaying, on the display, supplementary information, in addition to the basic information, for at least one of (a) the first viewing angle and (b) the second viewing angle.

30. An information system for occupants of a motor vehicle, comprising:
a display device having a display adapted to display different content as a function of a viewing angle; and
a control device adapted to control display of the content displayed by the display for at least two viewing angles;
wherein the control device is adapted to control the display such that basic information is displayable for both of the at least two viewing angles, and, in addition to the basic information, at least one of (a) first supplementary information is displayable for a first viewing angle and (b) second supplementary information is displayable for a second viewing angle.

31. The information system according to claim 30, further comprising a navigation device, the basic information including a map display for the navigation device.

32. The information system according to claim 31, wherein the display is touch-sensitive, points of interest selectable by touch of assigned icons on the map display.

33. The information system according to claim 31, further comprising at least one operation element offset from the display.

34. The information system according to claim 33, wherein the offset operation element is adapted to select points of interest.

35. The information system according to claim 30, wherein the information system is coupled to a speedometer, the control device adapted to modify a depth of detail of the display for the first viewing angle as a function of speed.
